(19) United States
(12) Patent Application Publication
(10) Pub. No.: US 2025/0347936 A1
(43) Pub. Date: Nov. 13, 2025

(54) DISPLAY DEVICE AND DISPLAY SYSTEM

(71) Applicant: Sharp Display Technology Corporation, Kameyama City (JP)

(72) Inventors: Takafumi MIURA, Kameyama City (JP); Masamitsu KOBAYASHI, Kameyama City (JP)

(21) Appl. No.: 19/199,964

(22) Filed: May 6, 2025

(30) Foreign Application Priority Data
May 10, 2024 (JP) 2024-077144

(51) Int. Cl. G02F 1/01; G02F 1/1335; G09G 3/34; G09G 3/36

(52) U.S. Cl. CPC G02F 1/0136; G09G 3/342; G09G 3/3648; G02F 1/133528; G09G 2320/0209; G09G 2340/10; G09G 2358/00

(57) ABSTRACT

A display device includes a display panel, a polarizing module placed over a screen of the display panel, and a control unit. The control unit generates, based on data for a secret image and data for a public image, data for a first image with a compressed gradation of the secret image and data for a second image reflecting a reverse image of the first image and the public image. The control unit causes the first and second images to be displayed by time division, and controls the polarizing module so that a state of polarization of the polarizing module is a first state of polarization during a period of display of the first image and is a second state of polarization during a period of display of the second image in synchronization with a timing of the time division.

### BACKGROUND

### 1. Field

The present disclosure relates to a display device and a display system.

### 2. Description of the Related Art

Flat-panel displays such as liquid crystal displays and organic EL displays are used in various types of device such as laptop PCs, mobile devices such as smartphones, and vehicles' instrument panels. In some cases, these devices display secret information, private information, or other information on the screen and are used so that only a particular person is allowed to visually recognize the information and another person is not allowed to recognize the information. For example, Japanese Patent No. 5299275 discloses an image processing device that allows only a user who looks at a display to view a secret image using shutter-equipped glasses.

It is desirable to provide a display device and a display system that allow only a particular person to visually recognize a particular image with higher image quality.

### SUMMARY

According to an aspect of the disclosure, there is provided a display device including a display panel, a polarizing module placed over a screen of the display panel and configured to actively switch between causing light emitted from the screen of the display panel to be transmitted in a first state of polarization and causing the light to be transmitted in a second state of polarization, and a control unit. The control unit generates, based on data for a secret image and data for a public image, data for a first image with a compressed gradation of the secret image and data for a second image reflecting a reverse image of the first image and the public image. The control unit causes the first image and the second image to be displayed by time division. The control unit controls the polarizing module so that a state of polarization of the polarizing module is the first state of polarization during a period of display of the first image and is the second state of polarization during a period of display of the second image in synchronization with a timing of the time division.

### BRIEF DESCRIPTION OF THE DRAWINGS

FIG. 1 is a schematic configuration diagram of a display system of a first embodiment;

FIG. 2 shows an example of a look-up table;

FIG. 3A shows an example of a secret image;

FIG. 3B shows an example of a public image;

FIG. 3C shows an example of a first image;

FIG. 3D shows an example of a second image;

FIG. 4 is a schematic view showing a state of polarization of a polarizing module, display of images on a liquid crystal display panel, and timings of turning on of a backlight;

FIG. 5 is a schematic view explaining an image that a first viewer visually recognizes;

FIG. 6 is a schematic view explaining an image that a second viewer visually recognizes;

FIG. 7A is a schematic view showing how crosstalk with a public image occurs in a secret image;

FIG. 7B is a schematic view showing how crosstalk with a secret image occurs in a public image;

FIG. 8 illustrates schematic tables explaining a process for creating sub-look-up tables;

FIG. 9 illustrates schematic tables explaining a process for creating sub-look-up tables;

FIG. 10 illustrates schematic tables explaining a process for creating sub-look-up tables;

FIG. 11 illustrates schematic tables explaining a process for creating sub-look-up tables;

FIG. 12 illustrates schematic tables explaining a process for creating sub-look-up tables;

FIG. 13 schematically shows changes in luminance tone values during frame periods of the liquid crystal display panel;

FIG. 14 is a schematic configuration diagram of a display system of a second embodiment; and

FIG. 15 is a schematic view showing a state of polarization of a polarizing module, display of images on a liquid crystal display panel, and timings of turning on of a backlight.

### DESCRIPTION OF THE EMBODIMENTS

Embodiments of the present disclosure are described below with reference to the drawings. The present disclosure is not limited to the following embodiments but can be designed and changed as appropriate as far as a configuration of the present disclosure is fulfilled. Further, in the following description, identical components or components having similar functions are given identical reference signs in common throughout different drawings, and a repeated description of such components may be omitted. Further, configurations described in the embodiments and modifications may be combined or may be changed as appropriate without departing from the scope of the present disclosure. For ease of understanding of explanation, the drawings to be referred to below may show configurations in a simplistic form or in a schematic form or may omit some constituent members. Further, dimensional ratios between constituent members shown in the drawings do not necessarily represent actual dimensional ratios.

### First Embodiment

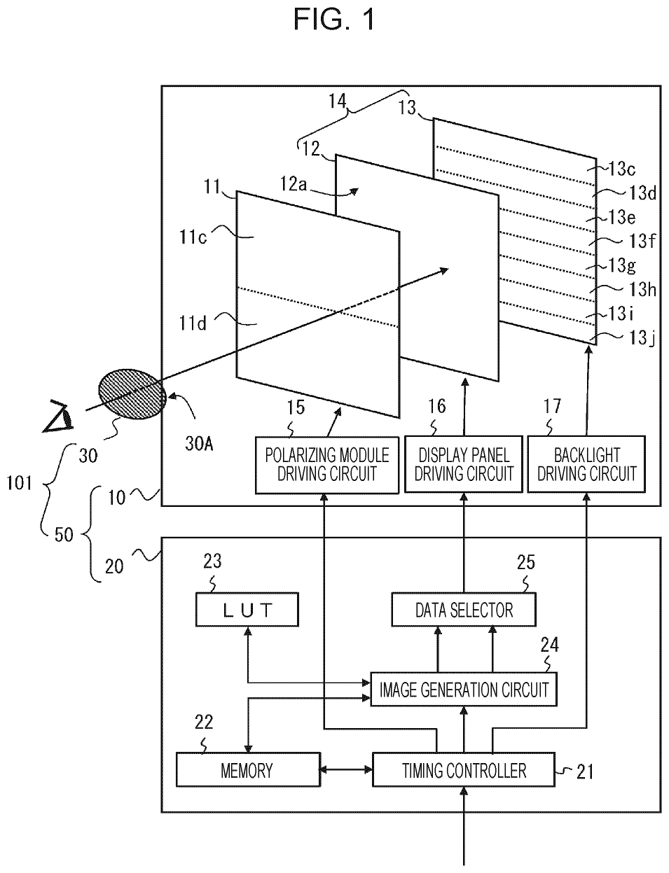

FIG. 1 is a schematic configuration diagram of a display system 101 of the present embodiment. The display system 101 includes a display device 50 and glasses 30. The display device 50 is mounted, for example, in a smartphone, a tablet terminal, a smartwatch, an on-board information display, a laptop personal computer, a personal computer, a monitor for use in a personal computer, a television, or other devices. The display device 50 includes a polarized display panel 10 and a control unit 20. Further, the polarized display panel 10 includes a polarizing module 11 and a display panel 14.

As will be described in detail below, the display panel 14 displays a first image and a second image on a screen 12a by time division, and the polarizing module 11 comes into a first state of polarization when the first image is displayed in synchronization with a timing of the time division and comes into a second state of polarization when the second image is displayed in synchronization with the timing of the time division. Examples of the first state of polarization and the second state of polarization include linear polarizations whose transmission axes are orthogonal to each other and circular polarizations whose directions of rotation are different from each other.

The control unit 20 generates, from data for a secret image that is presented to a first viewer and data for a public image that is presented to a second viewer, data for a first image with a compressed gradation of the secret image and data for a second image reflecting a reverse image of the first image and the public image. As will be described below, the compressed gradation manes a reduced number of tones and a narrower dynamic range of luminance.

With a polarizing plate 30A placed in the first state of polarization, the glasses 30 selectively transmit only the first image in the first state of polarization. For this reason, the first viewer, who is wearing the glasses 30, visually recognizes only the first image, which is the secret image. Meanwhile, the second viewer, who does not wear the glasses 30, is presented with the first image and the second image. A time integration effect of vision causes the second viewer to visually recognize, as the public image, a composite image made up of the first image and the second image. The display system 101 of the present embodiment uses such data for the first image and such data for the second image that the occurrence of crosstalk between the first image and the second image can be effectively reduced.

The following describes the display system 101 in detail. The display panel 14 may be a liquid crystal panel or may be a self-luminous panel such as an organic EL panel or a nano-LED panel, or a mini-LED panel. In the present embodiment, the display panel 14 includes a liquid crystal display panel 12 and a backlight 13. The liquid crystal display panel 12 can be driven by any driving system, and liquid crystal display panels that are driven by various types of driving system can be used. In a case where the display device 50 is mounted in a device configured to perform a wide viewing angle image display, a liquid crystal display panel that is driven in a transverse electric field mode such as FFS or IPS is suitably used.

The display panel 14 includes a plurality of pixels two-dimensionally arranged in a row-wise direction and a column-wise direction, a plurality of scanning lines, and a plurality of data lines. The plurality of scanning lines each extend in the row-wise direction and are arrayed in the column-wise direction. The plurality of data lines each extend in the row-wise direction and are arrayed in the column-wise direction. Since the column-wise direction is a direction in which the plurality of scanning lines are scanned, the column-wise direction is hereinafter called a “scanning direction”. Each pixel includes a pixel electrode and a TFT, and one of the plurality of scanning lines and one of the plurality of data lines are connected to a gate electrode and a source electrode, respectively, of the TFT of the pixel. Further, in each pixel, the pixel electrode is connected to a drain electrode of the TFT.

In the present embodiment, the backlight 13 is a partially drivable backlight. The backlight 13 may be of a direct type or may be of an edge type as long as it is partially drivable. The backlight 13 is, for example, a scanning backlight having a plurality of light sources that can be individually controlled. The light sources are, for example, LEDs (light-emitting diodes). The turning on and turning off of each of the plurality of light sources of the backlight 13 are individually controlled by the after-mentioned backlight driving circuit 17.

The backlight 13 can be controlled by the backlight driving circuit 17 to emit different amounts of light that vary between a period of display of the first image on the display panel 14 and a period of display of the second image on the display panel 14. Specifically, the backlight 13 can emit different amounts of light by varying the length of a period of glowing and/or the luminance of the light sources during glowing between the period of display of the first image on the display panel 14 and the period of display of the second image on the display panel 14. This makes it possible to appropriately regulate, according to characteristics such as conditions of response of the liquid crystal display panel 12 and the polarizing module 11, the amounts of light that are emitted from the backlight 13 during the period of display of the first image and the period of display of the second image, making it possible to further stabilize the luminance of an image that is displayed on the liquid crystal display panel 12.

Further, as shown in FIG. 1, the backlight 13 is divided into areas in a direction along the scanning lines of the liquid crystal display panel 12, can be kept turned off for a predetermined period of time since the start of writing of the data for the first image or the data for the second image, and can be turned on thereafter. As will be mentioned later, in the present embodiment, the timings of tuning on and turning off are varied between the period of display of the first image and the period of display of the second image. Although, in the example shown in FIG. 1, the backlight 13 is divided into eight areas 13c to 13j in the direction along the scanning lines, the backlight 13 may be divided into more than eight areas or may be divided into less than eight areas.

The polarizing module 11 is an active retarder configured to actively switch between causing light emitted from the screen 12a of the display panel 14 to be transmitted in the first state of polarization and causing the light to be transmitted in the second state of polarization. As mentioned above, the first state of polarization and the second state of polarization are, for example, linearly polarizations whose transmission axes are orthogonal to each other or circular polarizations one of which is a right-handed circular polarization and the other of which is a left-handed circular polarization.

In the present embodiment, the polarizing module 11 can independently control states of polarization in areas 11c and 11d into which the polarizing module 11 is divided in the scanning direction. Instead of being divided into two areas in the scanning direction, the polarizing module 11 may be divided into more than two areas or may be one area. Such a polarizing module 11 is used, for example, as a 3D image display technology or other technologies and can be implemented as an optical structure that switches between states of polarization using liquid crystal cells. Specifically, such a polarizing module 11 can be fabricated by using technologies disclosed, for example, in Japanese Unexamined Patent Application Publication No. 2023-104136, Japanese Unexamined Patent Application Publication No. 2023-107192, Japanese Unexamined Patent Application Publication No. 2023-157668, Japanese Unexamined Patent Application Publication No. 2024-008540, Japanese Patent Application No. 2022-206835, or other patent documents.

The polarized display panel 10 further includes a polarizing module driving circuit 15, a display panel driving circuit 16, and the backlight driving circuit 17. The polarizing module driving circuit 15 receives a synchronization signal from the control unit 20 and, in accordance with the synchronization signal, actively switches the states of polarization in the areas 11c and 11d of the polarizing module 11 between the first state of polarization and the second state of polarization.

The display panel driving circuit 16 receives an image signal and a start signal from the control unit 20, generates a scanning signal from the start signal, and generates a data signal from the image signal. The scanning lines are scanned by the scanning signal being applied to the scanning lines in sequence, and TFTs connected to the scanning lines become turned on. The data signal is applied to the data lines, and the data signal is applied to pixels whose TFTs are on.

The backlight driving circuit 17 receives the synchronization signal from the control unit 20 and, in accordance with the synchronization signal, selectively turns on the areas 13c to 13j of the backlight 13 in sequence in the scanning direction.

The glasses 30 are worn by the first viewer, who is supposed to visually recognize the secret image. The polarizing plate 30A is placed in the first state of polarization on a surface of the glasses 30. As mentioned above, the first state of polarization is a linear polarization or a circular polarization. The glasses 30 are not an active retarder, and there is no change in a state of polarization of the glasses 30. This makes it possible to make the glasses 30 simple in configuration.

Since the glasses 30 are worn by the first viewer, when the posture or head of the first viewer becomes tilted, the posture of the glasses 30 becomes tilted accordingly. As a result of that, in a case where the first state of polarization and the second state of polarization are linear polarizations, the transmission axis of the first state of polarization of the glasses 30 worn by the first viewer becomes non-parallel with the transmission axis of the first state of polarization presented by the polarized display panel 10, so that it becomes hard to visually recognize the secret image. In this case, the first viewer can increase viewability by changing the tilt of the heard in such a direction that it becomes easier to view the secret image. Further, in a case where the first state of polarization and the second state of polarization are circular polarizations, the first viewer can visually recognize the secret image without being affected by the posture of the glasses 30.

The control unit 20 includes a timing controller 21, a memory 22, a look-up table (LUT) 23, an image generation circuit 24, and a data selector 25.

The timing controller 21 receives, from an outside source, an image signal containing the data for the secret image and the data for the public image and stores the data for the secret image and the data for the public image in the memory 22. The data for the public image may be stored in advance in the memory 22 instead of being received from the outside source. The timing controller 21 further generates a synchronization signal from the image signal and outputs the synchronization signal to the polarizing module driving circuit 15 and the backlight driving circuit 17.

The look-up table 23 is a data set that is referred to so that the data for the first image that is displayed on the display panel 14 and the data for the second image that is displayed on the display panel 14 are generated from the data for the secret image and the data for the public image. The look-up table 23 is stored, for example, in a nonvolatile memory such as an EPROM or an EEPROM.

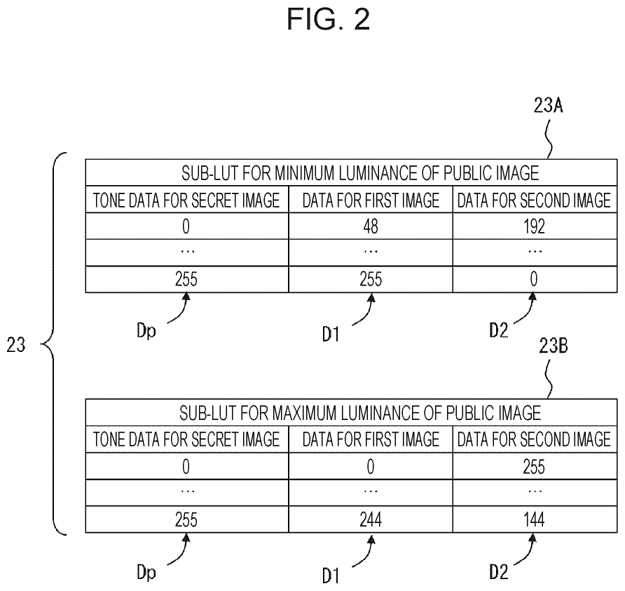

FIG. 2 shows an example of the look-up table 23. In the present embodiment, the look-up table 23 includes a sub-look-up table 23A for a tone of the minimum luminance of the public image and a sub-look-up table 23B for a tone of the maximum luminance of the public image. Each of the sub-look-up tables 23A and 23B includes a data set in which luminance tone values D1 of the first image and luminance tone values D2 of the second image are associated with luminance tone values Dp of the secret image. As will be described below, the gradation of luminance of the first image is compressed with respect to the gradation of luminance Dp of the secret image. That is, the number of tones of luminance of the first image is smaller than the number of tones of luminance of the secret image. For example, in a case where the secret image is represented by eight bits with a 256-step gradation, the number of tones of luminance is smaller than 256. In each of the sub-look-up tables 23A and 23B, the luminance tone values D1 of the first image and the luminance tone values D2 of the second image have color reversal relationships with each other.

The public image may be an image that is represented by two tones of luminance, namely the aforementioned maximum luminance and minimum luminance, or may be an image that is represented by three or more tones of luminance. In this case, the look-up table 23 may include as many sub-look-up tables as tones of luminance.

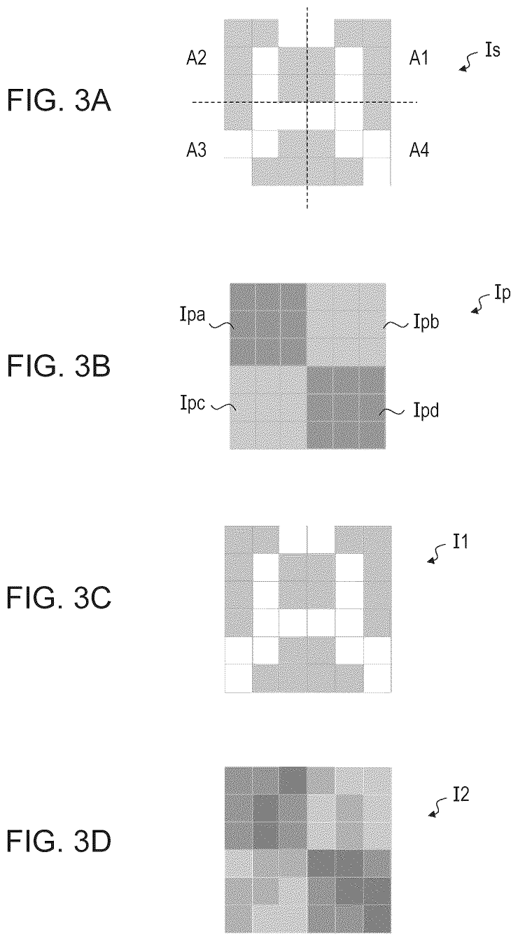

The image generation circuit 24 generates the data for the first image and the data for the second image with reference to the look-up table 23 on the basis of the data for the secret image and the data for the public image stored in the memory 22. FIGS. 3A and 3B show examples of the secret image and the public image. In the example shown in FIG. 3B, the public image is constituted by pixels of two tones of luminance, namely a tone of luminance Ipa and a tone of luminance Ipb that is higher than the tone of luminance Ipa. For this reason, the image generation circuit 24 generates the data for the first image and the data for the second image from the data for the secret image with reference to the sub-look-up table 23A for the minimum luminance for areas A2 and A4 of the secret image that correspond to the positions of pixels of the tone of luminance Ipa of the public image and generates the data for the first image and the data for the second image from the data for the secret image with reference to the sub-look-up table 23B for the maximum luminance for areas A1 and A3 of the secret image that correspond to the positions of pixels of the tone of luminance Ipb of the public image.

More specifically, the image generation circuit 24 finds out, from among the luminance tone values Dp of the secret image in the sub-look-up table 23A for the minimum luminance of FIG. 2, the tone values of pixels of the data for the secret image that are located in the areas A2 and A4 and determines the corresponding values from among the luminance tone values D1 of the first image and the luminance tone values D2 of the second image. Similarly, the image generation circuit 24 finds out, from among the luminance tone values Dp of the secret image in the sub-look-up table 23B for the maximum luminance of FIG. 2, the tone values of pixels of the data for the secret image that are located in the areas A1 and A3 and determines the corresponding values from among the luminance tone values D1 of the first image and the luminance tone values D2 of the second image.

Although, in FIG. 3B, the public image is constituted by a two-tone simple geometric pattern, the public image may be constituted by pixels of three or more tones of luminance, or the image may be a landscape other than the geometric pattern. In this case, the image generation circuit 24 generates the data for the first image and the data for the second image through the following procedure:
(1) Select one pixel of the public image and determine a sub-look-up table corresponding to the luminance value of the pixel;
(2) Determine a pixel of the secret image that corresponds to the selected pixel of the public image, find out the luminance of the pixel thus determined from among the luminance tone values Dp of the secret image of the sub-look-up table thus determined, and determine the corresponding values from among the luminance tone values D1 of the first image and the luminance tone values D2 of the second image; and
(3) Repeat steps (1) and (2) for anther pixel of the public image.

The image generation circuit 24 generates data for the whole first image and data for the whole second image in consideration of an arrangement of pixels from the luminance tone values D1 of the first image and the luminance tone values D2 of the second image thus obtained from each sub-look-up table. FIGS. 3C and 3D show examples of images by the data for the first image and the data for the second image generated through such a procedure.

The data selector 25 receives the data for the first image and the data for the second image from the image generation circuit 24 and generates an image signal in which the data for the first image and the data for the second image are alternately contained for each frame. The image signal thus generated is outputted to the display panel driving circuit 16. Further, the data selector 25 generates a start signal and outputs it to the display panel driving circuit 16.

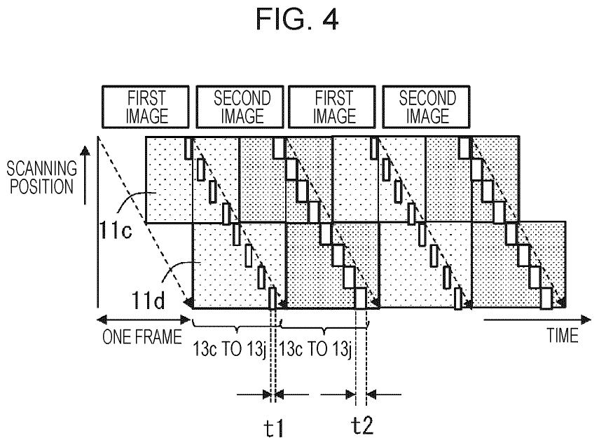

The following describes display of an image on the polarized display panel 10 by the control unit 20. FIG. 4 is a schematic view showing a state of polarization of the polarizing module 11, display of images on the liquid crystal display panel 12, and timings of turning on of the backlight 13. In FIG. 4, the horizontal axis represents time, and the vertical axis represents position in the direction of scanning of the scanning lines of the polarized display panel 10.

As shown in FIG. 4, the first image and the second image are alternately displayed for each frame on the liquid crystal display panel 12. Display of the images in each frame is performed, for example, every one scanning line by sequentially scanning each scanning line from a scanning line of the plurality of scanning lines located at an upper end to a scanning line located at a lower end as indicated by a dashed arrow. When the TFT of a pixel connected to a scanning line is turned on, a voltage corresponding to a tone value of the data for the first image or the data for the second image is applied from the data line to the pixel electrode via the TFT. This causes a voltage corresponding to the tone value to be applied to the pixel electrode, bringing a liquid crystal layer into a state of alignment corresponding to the tone value. Each pixel displays an image of the previous frame until the scanning line is scanned. For this reason, the first image or the second image to be displayed in each frame is completed at a timing when the scanning of the scanning line is completed.

In a case where the display panel 14 is a liquid crystal display panel, it may take time to reach a state of alignment of liquid crystals that corresponds to the value of a voltage applied to a pixel electrode. In this case, when the backlight 13 is turned on as a whole at a time, a difference between the time from the timing of the application of a voltage to the pixel electrode of a pixel scanned first and located in an upper part of the display panel 14 to the turning on of the backlight 13 and the time from the timing of the application of a voltage to the pixel electrode of a pixel scanned last and located in a lower part of the display panel 14 to the turning on of the backlight 13 is made during a one-frame period. For this reason, even if voltages of the same value are applied to the pixel electrodes so that the same luminance tone value is attained, the two pixels differ in luminance from each other and cause luminance unevenness all over the screen 12a.

In the present embodiment, such luminance unevenness is suppressed by dividing the backlight 13 into areas 13c to 13j in the scanning direction and sequentially turning on the areas thus divided after a certain period of time has elapsed since scanning lines situated in the corresponding locations were scanned. This makes it possible to equalize as much as possible the time from the timing of the application of a voltage to the pixel electrode of a pixel connected to one scanning line to the turning on of the backlight 13 and the time from the timing of the application of a voltage to the pixel electrode of a pixel connected to another scanning line to the turning on of the backlight 13, making it possible to suppress luminance unevenness all over the screen 12a. Controlling the backlight 13 in accordance with the synchronization signal in this way allows the display panel 14 to display the first image during a first period and display the second image during a second period.

The length of a first period t1 during which each of the areas 13c to 13j glows for the first image to be displayed is different from the length of a second period t2 during which each of the areas 13c to 13j glows for the second image to be displayed. This causes the backlight 13 to emit different amounts of light that vary between the first period t1 and the second period t2, making it possible to present the public image with a plurality of tones. Although, in the present embodiment, the second period t2 is set to be longer than the first period t1, the first period t1 may be longer than the second period t2.

For a similar reason, in a case where the polarizing module 11 is constituted by liquid crystal cells, there occur luminance unevenness and crosstalk between the first image and the second image if the time from the timing of the switching of the state of polarization between the first state of polarization and the second state of polarization to the turning on of the backlight 13 varies according to the position of the polarizing module 11. For this reason, in the present embodiment, in the area 11c of the polarizing module 11, for example, the state of polarization is switched at a timing when scanning of an upper half of scanning lines is completed, and in the area 11d, the state of polarization is switched at a timing when scanning of a lower half of scanning lines is completed. The polarizing module 11 is controlled in accordance with the synchronization signal so as to be in the first state of polarization during the first period during which the backlight 13 glows and be in the second state of polarization during the second period during which the backlight 13 glows.

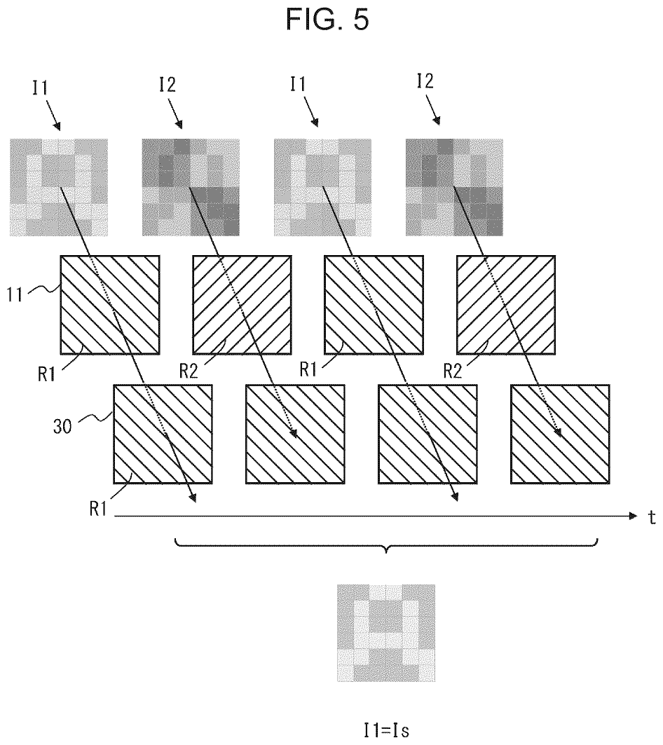

Next, overall operation of the display system 101 is described with reference to FIGS. 5 and 4. FIG. 5 is a schematic view explaining an image that the first viewer visually recognizes. The display panel 14 displays a first image I1 and a second image 12 by time division. As mentioned above, the polarizing module 11 is in a first state of polarization R1 during a period of display of the first image I1 and is in a second state of polarization R2 during a period of display of the second image 12 in synchronization with a timing of the time division.

Since the first viewer is wearing the glasses 30 on which a polarizing plate is placed in the first state of polarization R1, an image of the display panel 14 reaches the eyes of the first viewer through the glasses 30 only when there is an agreement in state of polarization. In the present embodiment, the second image 12 does not pass through the glasses 30 since there is no agreement in state of polarization, and only the first image I1 in the first state of polarization reaches the first viewer. This causes the first viewer to visually recognize the first image I1. The first image is the same as a secret image Is shown in FIG. 3A except for the compressed gradation of luminance.

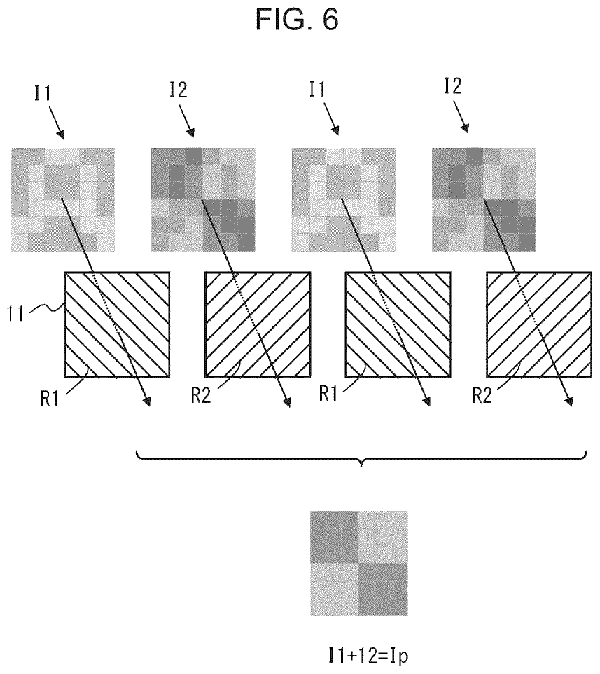

FIG. 6 is a schematic view explaining an image that the second viewer visually recognizes. The display panel 14 and the polarizing module 11 operate in the same manner as in the case of the first viewer.

Since the second viewer is not wearing the glasses 30, the first image I1 in the first state of polarization and the second image 12 in the second state of polarization reach the second viewer. Due to the time integration effect of vision, the second viewer visually recognizes a composite image made up of the first image and the second image. Since the second image 12 reflects the reverse image of the secret image and the public image, a component of the first image I1, which is the secret image, is canceled out by the second image 12 in the composite image. For this reason, the second viewer visually recognizes a public image Ip shown in FIG. 6.

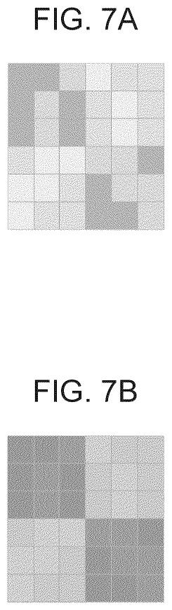

Note here that unless the look-up table 23 is not created as appropriate, there occurs crosstalk between the first image I1 and the second image 12, with the result that a component of the second image I1 overlaps the first image I1 or a component of the first image I1 overlaps the second image 12, for example, as shown in FIGS. 7A and 7B. For this reason, for example, a decrease in image quality of the secret image or the appearance of a component of the secret image in the public image can cause the second viewer to view the secret image as well as the public image.

The look-up table 23 that the control unit 20 of the display system 101 of the present embodiment includes can suppress such crosstalk. The following describes a method for creating the look-up table 23.

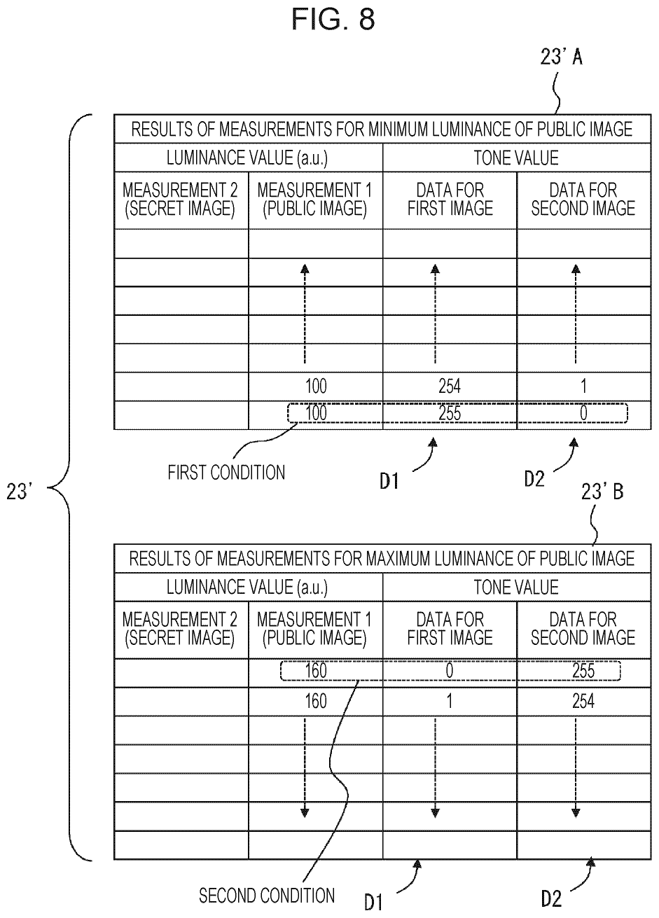

As mentioned earlier, the look-up table 23 includes the sub-look-up table 23A for the tone of the minimum luminance of the public image and the sub-look-up table 23B for the tone of the maximum luminance of the public image. FIGS. 8 to 12 each show a data set 23′ including schematic tables 23′A and 23′B explaining a process for creating the sub-look-up table 23A for the tone of the minimum luminance of the public image and the sub-look-up table 23B for the tone of the maximum luminance of the public image.

In a case where the second period, which is a period during which the backlight 13 glows for the second image to be displayed, is longer than the first period, which is a period during which the backlight 13 glows for the first image to be displayed, the public image, which is the composite image made up of the first image and the second image, reaches its minimum luminance when the second image is at its minimum luminance tone value of 0, and at this point in time, the first image is at its maximum luminance tone value of 255, which represents a reverse color.

Accordingly, the luminance of the screen 12a of the display panel 14 is measured (MEASUREMENT 1) with a luminance meter or other devices without the glasses 30 when a time-division display is performed at the maximum luminance tone value (255) during the first period and at the minimum luminance tone value (0) during the second period (first condition) either all over the display panel 14 or in an area sufficient to perform a luminance measurement. Let it be assumed that as shown in FIG. 8, the luminance thus measured of the display panel 14 is, for example, 100 (a.u.). It can also be said that MEASUREMENT 1 is a measurement of the luminance of the public image as visually recognized, as the measurement is performed without the glasses 30.

Then, the first image is set to a luminance tone value D1 of 254, and a luminance tone value D2 of the second image at which the same luminance is attained as in the case of the first condition is searched for. Similarly, as indicated by dashed arrows, the first image is set to luminance tone values D1 of 253, 252, 251, . . . , and 0, and luminance tone values D2 of the second image at which the same luminance is attained as in the case of the first condition are searched for. Note here that a combination of D1+D2=255 is not necessarily a combination of reverse colors, as the first period and the second period differ in length from each other and the response characteristics of the display panel 14 vary depending on combinations of a luminance tone value D1 of the first image and a luminance tone value D2 of the second image.

Similarly, as shown in the table 23′B, a combination of a luminance tone value D1 of the first image and a luminance tone value D2 of the second image at which the public image reaches its maximum luminance tone value is obtained. The composite image made up of the first image and the second image reaches its maximum luminance when the second image is at its maximum luminance tone value of 255, and at this point in time, the first image is at its minimum luminance tone value of 0, which represents a reverse color. The luminance of the screen 12a of the display panel 14 is measured with a luminance meter or other devices without the glasses 30 when a time-division display is performed at the minimum luminance tone value (0) during the first period and at the maximum luminance tone value (255) during the second period (second condition). Let it be assumed that the luminance thus measured of the display panel 14 is, for example, 160 (a.u.).

Then, the first image is set to a luminance tone value D1 of 1, and a luminance tone value D2 of the second image at which the same luminance is attained as in the case of the second condition is searched for. Similarly, as indicated by dashed arrows, the first image is set to luminance tone values D1 of 1, 2, 3, 4, . . . , and 255, and luminance tone values D2 of the second image at which the same luminance is attained as in the case of the second condition are searched for.

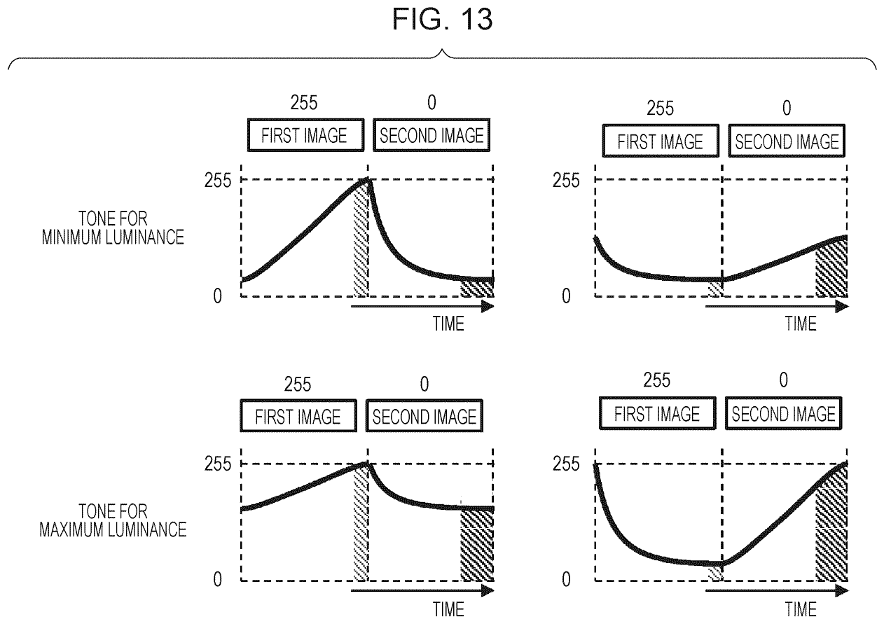

FIG. 13 schematically shows changes in luminance tone values during frame periods of the liquid crystal display panel 12 in the aforementioned measurement. Even when a luminance tone values D1 and a luminance tone values D2 are set, the liquid crystals are not in the corresponding state of alignment before the start of the first period and the second period; therefore, time-integrated values of luminance during the first period and the second period are affected by the luminance tone values D1 and the luminance tone values D2 or combinations of the luminance tone values D1 and the luminance tone values D2.

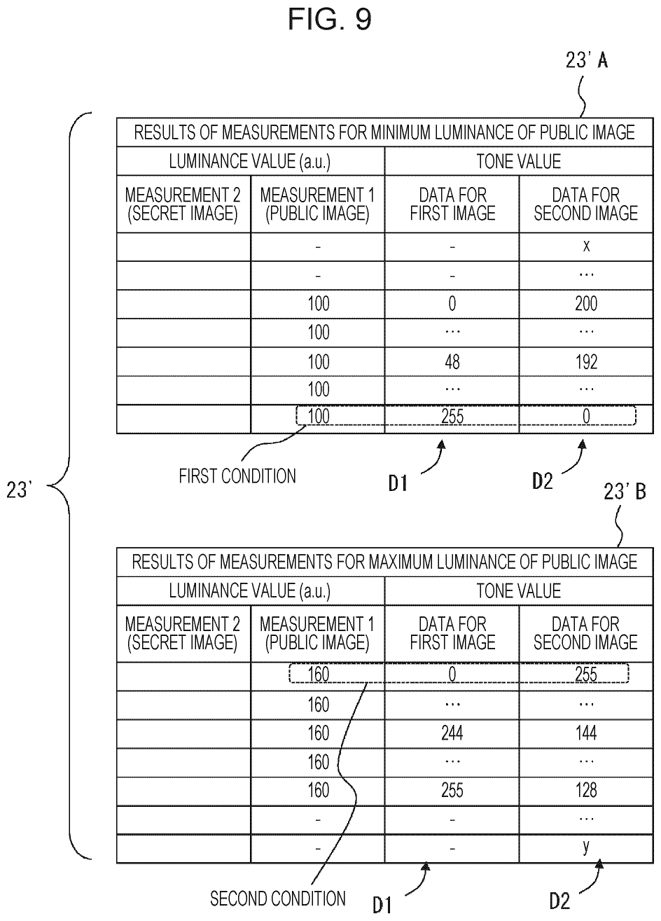

FIG. 9 shows results obtained by searching for a combination of a luminance tone values D1 and a luminance tone values D2 at which the public image reaches its minimum luminance tone value and results obtained by searching for a combination of a luminance tone values D1 and a luminance tone values D2 at which the public image reaches its maximum luminance tone value. Although, in the table 23′A, the second image is at a luminance tone value D2 of x in a case where the first image is at a luminance tone value D1 of 0, a luminance tone value D2 of the second image at which the same luminance is attached as in the case of the first condition may not be found in a case where a luminance tone value D2 of the second image is searched for with the first image at a luminance tone value D1 less than 255. This depends on the proportion in length of the first period t1 to the second period t2 and the display responsiveness of the display panel 14. Similarly, although, in the table 23′B, the second image is at a luminance tone value D2 of y in a case where the first image is at a luminance tone value D1 of 255, a luminance tone value D2 of the second image at which the same luminance is attached as in the case of the first condition may not be found in a case where a luminance tone value D2 of the second image is searched for with the first image at a luminance tone value D1 greater than 0. For this reason, the range of luminance tone values that the first image can assume can be narrower than the range of tones of luminance of the data for the secret image.

In the present embodiment, by actually measuring the luminance of the screen 12a of the display panel 14 and then determining a luminance tone value D1 and a luminance tone value D2 at which the same luminance is attainted as in the case of the first condition or the second condition, crosstalk between the first image and the second image can be suppressed in consideration of the responsiveness of the liquid crystal layer.

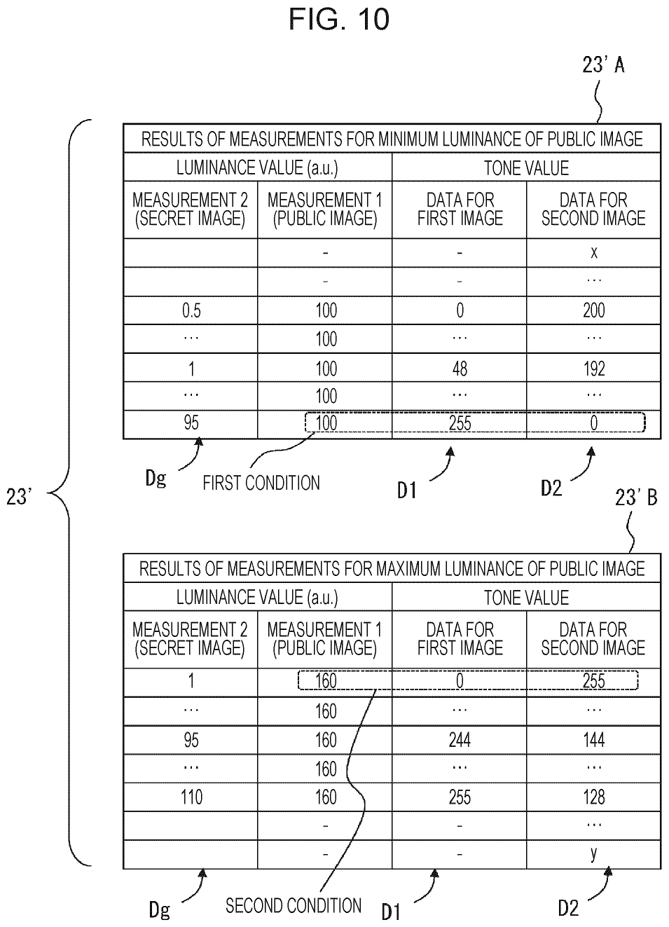

Next, the luminance of the screen 12a is measured via the polarizing module 11 and the glasses 30 with the display panel 14 glowing at combinations of a luminance tone value D1 and a luminance tone value D2 in each of the tables 23′A and 23′B as shown in FIG. 10. As shown in MEASUREMENT 2 and luminance tone value Dg of the table 23′A, the luminance thus measured varies from 0.5 to 95 (a.u.), for example, depending on values of data D1 for the first image and data D2 for the second image. Similarly, as shown in MEASUREMENT 2 and luminance tone value Dg of the table 23′B, the luminance thus measured varies from 1 to 110 (a.u.), for example, depending on values of the data D1 for the first image and the data D2 for the second image. It can also be said that MEASUREMENT 2 is a measurement of the luminance of the secret image as visually recognized, as the measurement is performed via the glasses 30.

In a case where the data D1 for the first image and the data D2 for the second image for the minimum luminance of the public image are used (table 23′A), the luminance value Dg of MEASUREMENT 2 as measured via the glasses 30 ranges from 0.5 to 95. Meanwhile, in a case where the data D1 for the first image and the data D2 for the second image for the maximum luminance of the public image are used (table 23′B), the luminance value Dg of MEASUREMENT 2 as measured via the glasses 30 ranges from 1 to 110. These two ranges of luminance values are different from each other. In other words, while the secret image can be displayed within the range of luminance values of 0.5 to 95 under conditions (i.e. a combination of the data D1 for the first image and the data D2 for the second image) where the public image is displayed at the minimum luminance, the secret image can be displayed within the range of luminance values of 1 to 110 under conditions (i.e. a combination of the data D1 for the first image and the data D2 for the second image) where the public image is displayed at the maximum luminance. This discrepancy (difference) between the ranges of luminance values at which the secret image can be displayed becomes a factor for crosstalk.

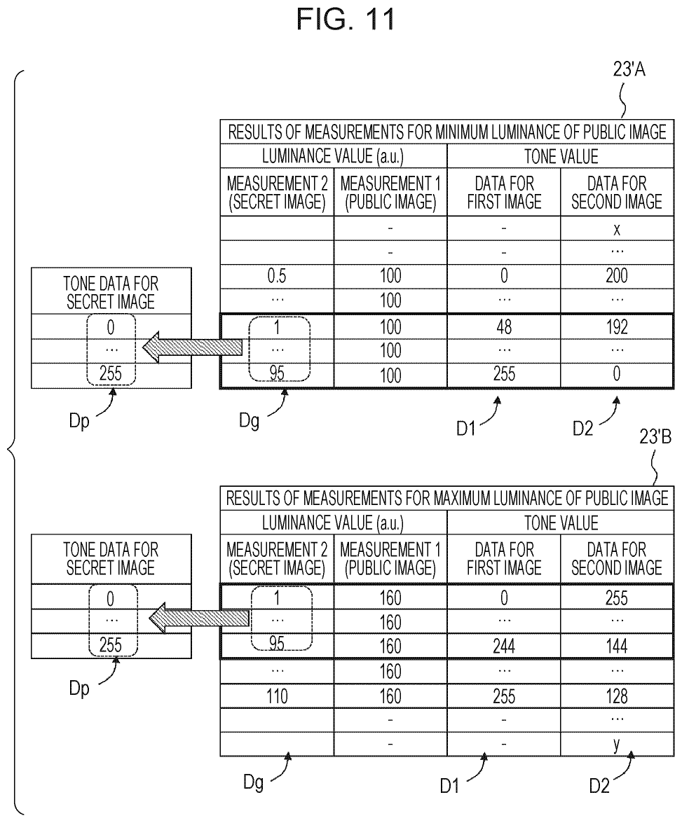

For this reason, a range of luminance values of the secret image is extracted so that a range of luminance values Dg at which the secret image can be displayed in a case where the data D1 for the first image and the data D2 for the second image for the minimum luminance of the public image are used (table 23′A) and a range of luminance values Dg at which the secret image can be displayed in a case where the data D1 for the first image and the data D2 for the second image for the maximum luminance of the public image are used (table 23′B) match. Specifically, as shown in FIG. 11, a range of luminance values Dg of 1 to 95 of the secret image enclosed by a heavy line (i.e. a range of common luminance values Dg of MEASUREMENT 2 in the tables 23′A and 23′B) is extracted. As a result of this, the minimum luminance value Dg at which the secret image can be displayed in a case where the public image is displayed at the minimum luminance is compressed (raised) to 1, and the maximum luminance value Dg at which the secret image can be displayed in a case where the public image is displayed at the maximum luminance is compressed (cut down) to 95. Accordingly, the ranges of tone values of the data for the first image in the tables 23′A and 23′B are compressed to parts of the range of 0 to 255.

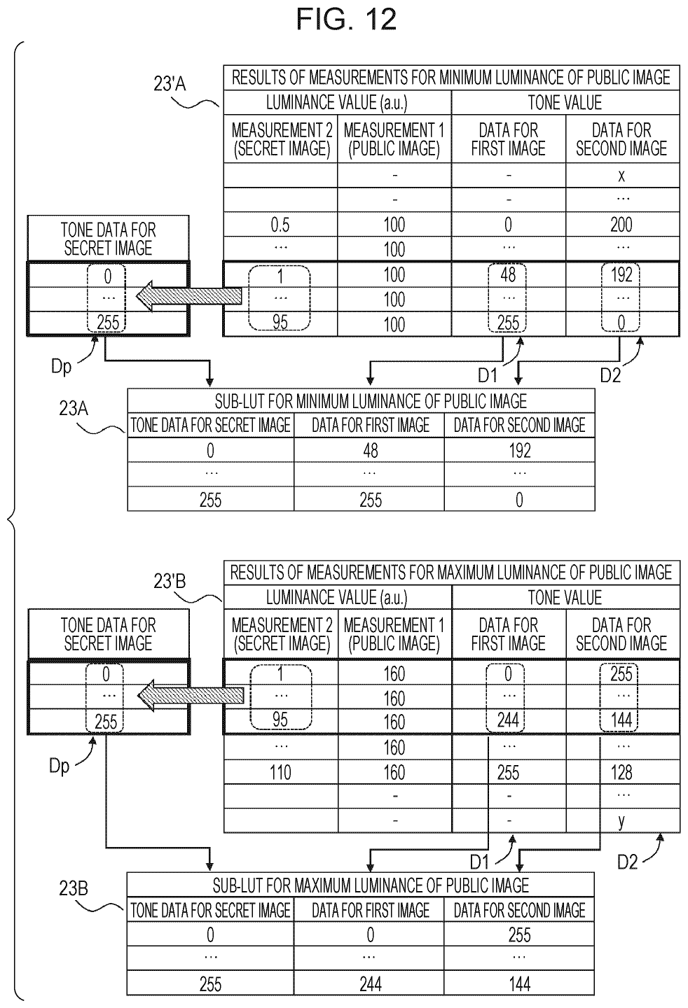

Next, as shown in FIG. 11, in each of the cases where the data D1 for the first image and the data D2 for the second image for the minimum luminance of the public image are used (table 23′A) and where the data D1 for the first image and the data D2 for the second image for the maximum luminance of the public image are used (table 23′B), the range of luminance values Dg of MEASUREMENT 2 thus measured is associated with tone data 0 to 255 of the secret image using luminance characteristics such as gamma 2.2. Since the range of luminance values Dg of MEASUREMENT 2 is compressed as mentioned above, the association with the tone data 0 to 255, it can be said that the association with the tone data 0 to 255 is an expansion of the gradation. Further, this association causes the tone data 0 to 255 of the secret image to be also associated with the data D1 for the first image and the data D1 for the first image in tables 23′A and 23′B. The range of tone values of the data D1 for the first image is narrower (compressed) than the range of 0 to 255, and the number of tones is decreased. Furthermore, as shown in FIG. 12, D1 and D2 enclosed by heavy lines in the tables 23′A and 23′B are extracted in association with tone data Dp of the secret image of 0 to 255. As a result of this, the sub-look-up table 23A for the tone of the minimum luminance of the public image and the sub-look-up table 23B for the tone of the maximum luminance of the public image shown in FIG. 2 are obtained. The image generation circuit 24 generates the data for the first image with a compressed gradation of the secret image by using the sub-look-up tables 23A and 23B.

The luminance of the display panel 14 as measured via the polarizing module 11 and the glasses 30 in a case where the display panel 14 glows at a luminance tone value D1 (255) of the first image and a luminance tone value D2 (0) of the second image that correspond to the maximum luminance value (255) of the secret image in the sub-look-up table 23A for the tone of the minimum luminance thus obtained is equal to the luminance of the display panel 14 as measured via the polarizing module 11 and the glasses 30 in a case where the display panel 14 glows at a luminance tone value D1 (244) of the first image and a luminance tone value D2 (144) of the second image that correspond to the maximum luminance value (255) of the secret image in the sub-look-up table 23B for the tone of the maximum luminance.

Similarly, the luminance of the display panel 14 as measured via the polarizing module 11 and the glasses 30 in a case where the display panel 14 glows at a luminance tone value D1 (0) of the first image and a luminance tone value D2 (255) of the second image that correspond to the minimum luminance value (0) of the secret image in the sub-look-up table 23B for the tone of the maximum luminance thus obtained is equal to the luminance of the display panel 14 as measured via the polarizing module 11 and the glasses 30 in a case where the display panel 14 glows at a luminance tone value D1 (48) of the first image and a luminance tone value D2 (192) of the second image that correspond to the minimum luminance value (0) of the secret image in the sub-look-up table 23A for the tone of the minimum luminance.

By thus setting the number of tones of luminance in the first image to be smaller than the number of tones of luminance of the secret image, the maximum luminance and minimum luminance of the first image can be held unchanged regardless of a luminance tone value of the public image even if the public image is constituted by two or more tones. This allows the first image to be presented to the first viewer without being affected by a tone of luminance of the public image. This also allows the public image to be presented to the second viewer without being affected by a tone of luminance of the first image. That is, crosstalk between the first image and the second image can be suppressed.

Further, the look-up table 23 is created based on values actually measured using the display panel 14. This makes it possible to present the first viewer and the second viewer with the secret image and the public image reflecting the display responsiveness of the display panel 14, making it possible to further suppress the crosstalk between the first image and the second image.

According to the present embodiment, since the display device 50 includes the look-up table 23 including the aforementioned sub-look-up table 23A for the tone of the minimum luminance and he aforementioned sub-look-up table 23B for the tone of the maximum luminance, crosstalk between the secret image and the public image is suppressed, so that the first viewer is allowed to visually recognize the secret image with higher image quality. Further, the second viewer is restrained from visually recognizing the secret image.

### Second Embodiment

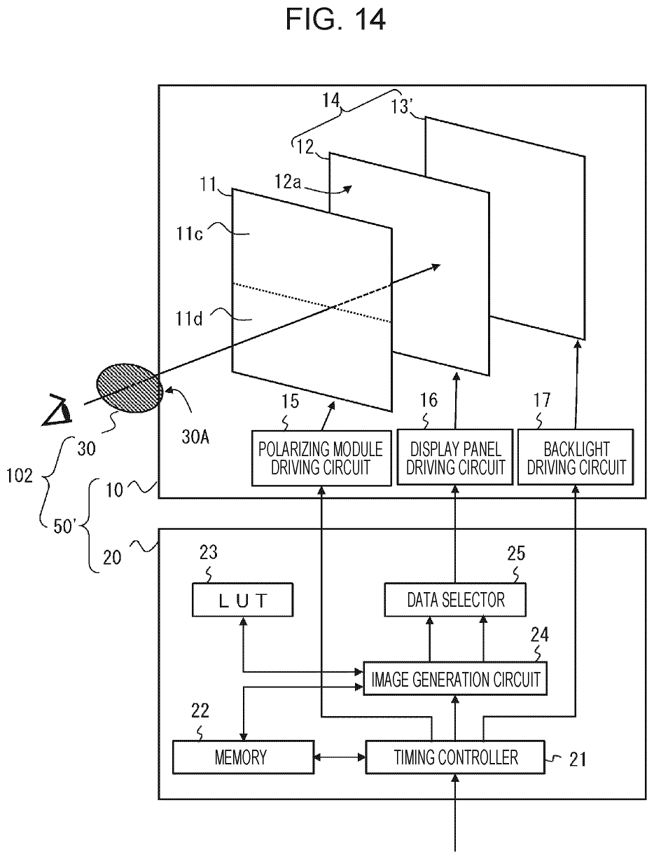

FIG. 14 is a schematic configuration diagram of a display device 50′ and a display system 102 of the present embodiment. The display system 102 differs from the display device 50 and the display system 101 in that the display system 102 includes a backlight 13′ that is integrally turned on and turned off as a whole.

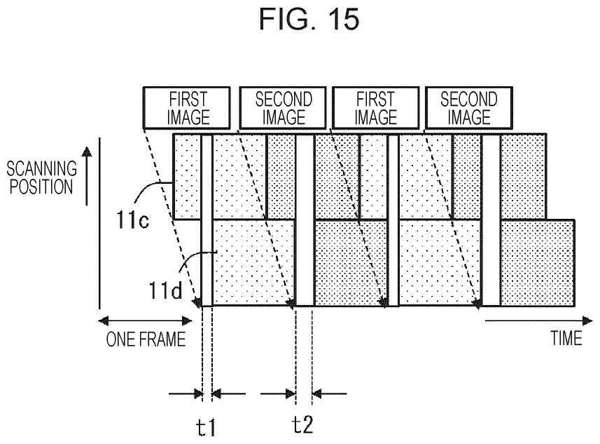

FIG. 15 is a schematic view showing a state of polarization of the polarizing module 11, display of images on the liquid crystal display panel 12, and timings of turning on of the backlight 13′. In FIG. 15, the horizontal axis represents time, and the vertical axis represents position in the direction of scanning of the scanning lines of the polarized display panel 10.

As shown in FIG. 15, the backlight 13′ glows all at once after, in each frame, scanning of the scanning lines has ended and display of the first image or the second image has been completed. During a period of glowing of the backlight 13′, the first image and the second image are alternately displayed for each frame on the liquid crystal display panel 12. Display of the images in each frame is performed every one scanning line by scanning the scanning lines as indicated by a dashed arrow. When the TFT of a pixel connected to a scanning line is turned on, a voltage corresponding to a tone value of the data for the first image or the data for the second image is applied from the data line to the pixel electrode via the TFT. This causes a voltage corresponding to the tone value to be applied to the pixel electrode, bringing a liquid crystal layer into a state of alignment corresponding to the tone value. Each pixel displays an image of the previous frame until the scanning line is scanned. For this reason, the first image or the second image to be displayed in each frame is completed at a timing when the scanning of the scanning line is completed. After completion of the display of the first image, the backlight 13′ glows for the first period t1, and after completion of the display of the second image, the backlight 13′ glows for the second period t2. As in the case of the first embodiment, using the backlight 13′ thus driven suppresses crosstalk between the secret image and the public image, allowing the first viewer to visually recognize the secret image with higher image quality. Further, the second viewer is restrained from visually recognizing the secret image.

### Other Embodiments

A display device and a display system of the present embodiment can be altered in various ways without being limited to the foregoing embodiments. Further, as mentioned above, the display device is not limited to a liquid crystal display device but may be an organic EL display device, a mini-LED display device, or other devices.

Further, in a case where the display panel 14 is a liquid crystal display panel, the display responsiveness can vary with temperature. For this reason, the control unit 20 may include a plurality of different look-up tables 23 for temperature created based on measurements performed at different temperatures. In this case, the control unit 20 may further include a temperature sensor or other devices, and based on ambient temperature measured by the temperature sensor, the control unit 20 may select one of the plurality of look-up tables 23 for use.

Further, the control unit 20 may include a look-up table 23 for each color of RGB, and the look-up table 23 may be used in common for each color of RGB.

Further, in the foregoing embodiment, the amount of light that is emitted from the backlight 13 is varied by making the length of the first period t1 during which to display the first image and the length of the second period t2 during which to display the second image different from each other. Alternatively, the amount of light that is emitted from the backlight 13 may be varied by, while making the length of the first period t1 and the length of the second period t2 equal to each other, varying the luminance of light that is emitted from the light sources of the backlight 13. Both the lengths of the first period t1 and the second period t2 and the luminance of light that is emitted may be varied.

A display device and a display system of the present disclosure can also be described in the following manner.

A display device according to a first configuration is a display device including a display panel, a polarizing module placed over a screen of the display panel and configured to actively switch between causing light emitted from the screen of the display panel to be transmitted in a first state of polarization and causing the light to be transmitted in a second state of polarization, and a control unit. The control unit generates, based on data for a secret image and data for a public image, data for a first image with a compressed gradation of the secret image and data for a second image reflecting a reverse image of the first image and the public image. The control unit causes the first image and the second image to be displayed by time division. The control unit controls the polarizing module so that a state of polarization of the polarizing module is the first state of polarization during a period of display of the first image and is the second state of polarization during a period of display of the second image in synchronization with a timing of the time division.

According to the first configuration, the number of tones of luminance of the first image is smaller than the number of tones of luminance of the secret image; therefore, even in a case where the public image is constituted by two or more tones, the maximum luminance and minimum luminance of the first image can each be held unchanged regardless of a luminance tone value of the public image. For this reason, crosstalk between the first image and the second image is suppressed.

A display device according to a second configuration may be directed to the first configuration, wherein the first state of polarization and the second state of polarization are linear polarizations whose transmission axes are orthogonal to each other.

A display device according to a third configuration may be directed to the first configuration, wherein the first state of polarization and the second state of polarization are circular polarizations one of which is a right-handed circular polarization and the other of which is a left-handed circularly polarization.

A display device according to a fourth configuration may be directed to the first configuration, wherein a length of a first period during which the display panel displays the first image is different from a length of a second period during which the display panel displays the second image.

A display device according to a fifth configuration may be directed to the fourth configuration, wherein the control unit includes an image generation circuit and a look-up table, and the image generation circuit generates the data for the first image and the data for the second image with reference to the look-up table from the data for the secret image and the data for the public image.

A display device according to a sixth configuration may be directed to the fifth configuration, wherein the public image is constituted by at least two different tones of luminance including a maximum luminance and a minimum luminance, the look-up table includes at least two sub-look-up tables including a sub-look-up table for a tone of the maximum luminance of the public image and a sub-look-up table for a tone of the minimum luminance of the public image, and each of the sub-look-up tables includes a data set in which luminance tone values of the first image and luminance tone values of the second image are associated with luminance tone values of the secret image.

A display device according to a seventh configuration may be directed to the sixth configuration, wherein in each of the sub-look-up tables, the luminance tone values of the second image with respect to the luminance tone values of the first image are determined based on display responsiveness of the display panel.

A display device according to an eighth configuration may be directed to the seventh configuration, wherein the second period is longer than the first period.

A display device according to a ninth configuration may be directed to the eighth configuration, wherein the luminance tone values of the first image and the luminance tone values of the second image in the sub-look-up table for the tone of the minimum luminance are a combination of luminance tone values of the display panel during the first period and luminance tone values of the display panel during the second period selected so that a luminance is attained that is equal to a luminance of the display panel as measured in a case where the display panel is driven under a first condition where a time-division display is performed at a maximum luminance tone value during the first period and at a minimum luminance tone value during the second period, and the first condition corresponds to a maximum luminance tone value of the first image.

A display device according to a tenth configuration may be directed to the ninth configuration, wherein the luminance tone values of the first image and the luminance tone values of the second image in the sub-look-up table for the tone of the maximum luminance are a combination of luminance tone values of the display panel during the first period and luminance tone values of the display panel during the second period selected so that a luminance is attained that is equal to a luminance of the display panel as measured in a case where the display panel is driven under a second condition where a time-division display is performed at a minimum luminance tone value during the first period and at a maximum luminance tone value during the second period, and the second condition corresponds to a minimum luminance tone value of the first image.

A display system according to an eleventh configuration includes the display device according to any one of the first to tenth configurations and glasses on which a polarizing plate is placed in the first state of polarization.

A display system according to a twelfth configuration may be directed to the eleventh configuration, wherein a first viewer visually recognizes the first image by viewing the screen of the display panel via the polarizing module and the glasses, and by viewing the screen via the polarizing module, a second viewer who does not wear the glasses visually recognizes, as the public image, a composite image made up of the first image and the second image.

The present disclosure contains subject matter related to that disclosed in Japanese Priority Patent Application JP 2024-077144 filed in the Japan Patent Office on May 10, 2024, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display panel;
a polarizing module placed over a screen of the display panel and configured to actively switch between causing light emitted from the screen of the display panel to be transmitted in a first state of polarization and causing the light to be transmitted in a second state of polarization; and
a control unit,
wherein
the control unit generates, based on data for a secret image and data for a public image, data for a first image with a compressed gradation of the secret image and data for a second image reflecting a reverse image of the first image and the public image,
the control unit causes the first image and the second image to be displayed by time division, and
the control unit controls the polarizing module so that a state of polarization of the polarizing module is the first state of polarization during a period of display of the first image and is the second state of polarization during a period of display of the second image in synchronization with a timing of the time division.

2. The display device according to claim 1, wherein the first state of polarization and the second state of polarization are linear polarizations whose transmission axes are orthogonal to each other.

3. The display device according to claim 1, wherein the first state of polarization and the second state of polarization are circular polarizations one of which is a right-handed circular polarization and the other of which is a left-handed circularly polarization.

4. The display device according to claim 1, wherein a length of a first period during which the display panel displays the first image is different from a length of a second period during which the display panel displays the second image.

5. The display device according to claim 4, wherein
the control unit includes an image generation circuit and a look-up table, and
the image generation circuit generates the data for the first image and the data for the second image with reference to the look-up table from the data for the secret image and the data for the public image.

6. The display device according to claim 5, wherein
the public image is constituted by at least two different tones of luminance including a maximum luminance and a minimum luminance,
the look-up table includes at least two sub-look-up tables including a sub-look-up table for a tone of the maximum luminance of the public image and a sub-look-up table for a tone of the minimum luminance of the public image, and
each of the sub-look-up tables includes a data set in which luminance tone values of the first image and luminance tone values of the second image are associated with luminance tone values of the secret image.

7. The display device according to claim 6, wherein in each of the sub-look-up tables, the luminance tone values of the second image with respect to the luminance tone values of the first image are determined based on display responsiveness of the display panel.

8. The display device according to claim 7, wherein the second period is longer than the first period.

9. The display device according to claim 8, wherein
the luminance tone values of the first image and the luminance tone values of the second image in the sub-look-up table for the tone of the minimum luminance are a combination of luminance tone values of the display panel during the first period and luminance tone values of the display panel during the second period selected so that a luminance is attained that is equal to a luminance of the display panel as measured in a case where the display panel is driven under a first condition where a time-division display is performed at a maximum luminance tone value during the first period and at a minimum luminance tone value during the second period, and
the first condition corresponds to a maximum luminance tone value of the first image.

10. The display device according to claim 9, wherein
the luminance tone values of the first image and the luminance tone values of the second image in the sub-look-up table for the tone of the maximum luminance are a combination of luminance tone values of the display panel during the first period and luminance tone values of the display panel during the second period selected so that a luminance is attained that is equal to a luminance of the display panel as measured in a case where the display panel is driven under a second condition where a time-division display is performed at a minimum luminance tone value during the first period and at a maximum luminance tone value during the second period, and
the second condition corresponds to a minimum luminance tone value of the first image.

11. A display system comprising:
the display device according to claim 1; and
glasses on which a polarizing plate is placed in the first state of polarization.

12. The display system according to claim 11, wherein
a first viewer visually recognizes the first image by viewing the screen of the display panel via the polarizing module and the glasses, and
by viewing the screen via the polarizing module, a second viewer who does not wear the glasses visually recognizes, as the public image, a composite image made up of the first image and the second image.
